(19) United States
(12) Patent Application Publication
(10) Pub. No.: US 2020/0234422 A1
(43) Pub. Date: Jul. 23, 2020

(54) IMAGE INSPECTION DEVICE, IMAGE FORMING SYSTEM, IMAGE INSPECTION METHOD, AND RECORDING MEDIUM

(71) Applicant: KONICA MINOLTA, INC., Tokyo (JP)

(72) Inventors: Yoshihiro ESUMI, Tokyo (JP); Makoto OKI, Tokyo (JP)

(73) Assignee: KONICA MINOLTA, INC., Tokyo (JP)

(21) Appl. No.: 16/743,475

(22) Filed: Jan. 15, 2020

(30) Foreign Application Priority Data
Jan. 22, 2019 (JP) 2019-008240

(51) Int. Cl. G06T 7/00; H04N 1/00

(52) U.S. Cl. CPC G06T 7/001; H04N 1/00005; G06T 2207/30168; H04N 1/00082; G06T 2207/10008; H04N 1/00015

(57) ABSTRACT

An image inspection device includes a hardware processor. The hardware processor (i) captures a read image from a reading device, (ii) compares a reference image and an inspection image obtained by reading a paper sheet targeted for inspection on which an image corresponding to the reference image has been formed with the reading device, to inspect the inspection image, (iii) sets a first alignment region having a predetermined width on a leading end side of each of the reference image and the inspection image in a conveyance direction, and sets a second alignment region having a predetermined width on a rear end side in the conveyance direction, and (iv) corrects the reference image on a basis of amounts of positional deviation of the first alignment region and the second alignment region.

### CROSS-REFERENCE TO RELATED APPLICATIONS

The entire disclosure of Japanese Patent Application No. 2019-008240 filed on Jan. 22, 2019 is incorporated herein by reference in its entirety.

### BACKGROUND

### Technological Field

The present invention relates to an image inspection device, an image forming system, an image inspection method, and a recording medium.

### Description of the Related Art

Usually, when performing high-volume printing, test printing is performed several times to make various adjustments, and in a case where it is confirmed from a proof that there is no problem in print details, production printing is started. However, chromatic aberration or distortion may occur in an image on a paper sheet obtained by production printing with respect to the proof because of some factor. Thus, in recent years, a scanner is provided on a conveyance path in a stage subsequent to an image forming device, and an image on each paper sheet being printed and output is read with the scanner for inspection. In this inspection, an image read with the scanner when printing and outputting the proof is stored as a reference image, and an image (inspection image) obtained by reading a paper sheet printed in production printing with the scanner is compared with the stored reference image.

In the case of comparing images, it is common to compare the images after extracting feature points in the respective images, calculating the amount of deviation in rotation angle, the amount of deviation in magnification (X/Y), the amount of deviation in shift (X/Y), and the like on the basis of the positional relationship between the feature points, and performing image correction (affine transformation or the like) on the basis of the amounts of deviation.

As described above, image alignment significantly contributes to the inspection accuracy when performing image inspection by comparing images. Therefore, it is important to perform alignment with high accuracy.

As a technology of aligning images for inspection, there is disclosed a technology of setting a previously defined region as an important region in advance, and increasing a weight of a feature for alignment (for example, see JP2014-126445A).

There is also disclosed a technology of calculating the amount of positional deviation of a reference point, and excluding a portion having a large difference from an image comparing region (for example, see JP2014-199248A).

There is also disclosed a technology of extracting a corner of a shape included in an image for inspection, and setting the corner as a reference point for aligning the image for inspection and a read image (for example, see JP2013-57661A).

### SUMMARY

In an inspection device that changes a paper sheet discharge tray on the basis of an inspection result of an image read in-line with a scanner provided in a stage subsequent to an image forming device of an electrophotographic system or the like, it is necessary to complete processing such as detection of the amount of positional deviation, image correction, and image comparison before arriving at a point of changing the paper discharge tray.

Since it is difficult to sufficiently ensure the distance (time) to the changing point except a large-scale printing machine such as an offset printing machine, inspection needs to be accelerated and brought forward where possible.

However, it is difficult to simplify or omit detection of the amount of positional deviation which requires long time in the inspection because the detection exerts a great influence upon the inspection accuracy.

Thus, a method of acceleration by limiting a region in which feature points for alignment are to be extracted can be considered as in the above-described technologies described in JP2014-126445A, JP2014-199248A, and JP2013-57661A, but it is difficult to limit a region for a printing matter having various types of user content. Further, since the alignment accuracy degrades if the region is small, it is necessary to ensure the largest possible region.

The above-described technologies described in JP2014-126445A, JP2014-199248A, and JP2013-57661A perform alignment on regions or reference points defined in advance, and thus raise an issue of being unadaptable to various types of content. There is also an issue that, since alignment is performed using the entire image, it is difficult to perform high-speed inspection.

This invention has an object to provide an image inspection device, an image forming system, an image inspection method, and a recording medium that can accelerate inspection while ensuring the inspection accuracy.

To achieve at least one of the abovementioned objects, according to an aspect of the present invention, an image inspection device includes:

a hardware processor, wherein

the hardware processor

captures a read image from a reading device that optically reads a paper sheet output from an image forming device that forms an image on the paper sheet,

compares a reference image and an inspection image obtained by reading a paper sheet targeted for inspection on which an image corresponding to the reference image has been formed with the reading device, to inspect the inspection image,

sets a first alignment region having a predetermined width on a leading end side of each of the reference image and the inspection image in a conveyance direction, and sets a second alignment region having a predetermined width on a rear end side in the conveyance direction,

extracts a feature of each of the first alignment region and the second alignment region,

detects amounts of positional deviation of the first alignment region and the second alignment region on a basis of the extracted features,

corrects the reference image on a basis of the detected amounts of positional deviation, and

compares the corrected reference image and the inspection image.

According to another aspect of the present invention, an image forming system includes:

an image forming device that forms an image on a paper sheet;

a reading device that optically reads the paper sheet output from the image forming device; and

the image inspection device.

According to still another aspect of the present invention, an image inspection method for an image inspection device includes:

a capturing step of capturing a read image from a reading device that optically reads a paper sheet output from an image forming device that forms an image on the paper sheet; and

an image inspection step of comparing a reference image and an inspection image captured in the capturing step, obtained by reading a paper sheet targeted for inspection on which an image corresponding to the reference image has been formed with the reading device, to inspect the inspection image, wherein

the image inspection step includes
a region setting step of setting a first alignment region having a predetermined width on a leading end side of each of the reference image and the inspection image in a conveyance direction, and setting a second alignment region having a predetermined width on a rear end side in the conveyance direction,
an extraction step of extracting a feature of each of the first alignment region and the second alignment region set in the region setting step,
a detection step of detecting amounts of positional deviation of the first alignment region and the second alignment region on a basis of the features extracted in the extraction step,
a correction step of correcting the reference image on a basis of the amounts of positional deviation detected in the detection step, and
an image comparing step of comparing the reference image corrected in the correction step and the inspection image.

According to still another aspect of the present invention, a non-transitory recording medium has a computer-readable program stored therein, causing a computer to function as:

a capturer that captures a read image from a reading device that optically reads a paper sheet output from an image forming device that forms an image on the paper sheet; and

an image inspector that compares a reference image and an inspection image captured by the capturer, obtained by reading a paper sheet targeted for inspection on which an image corresponding to the reference image has been formed with the reading device, to inspect the inspection image, wherein

the image inspector includes
a region setter that sets a first alignment region having a predetermined width on a leading end side of each of the reference image and the inspection image in a conveyance direction, and sets a second alignment region having a predetermined width on a rear end side in the conveyance direction,
an extractor that extracts a feature of each of the first alignment region and the second alignment region set by the region setter,
a detector that detects amounts of positional deviation of the first alignment region and the second alignment region on a basis of the features extracted by the extractor,
a corrector that corrects the reference image on a basis of the amounts of positional deviation detected by the detector, and
an image comparator that compares the reference image corrected by the corrector and the inspection image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention.

FIG. 1 is a diagram showing a schematic configuration of an image forming system according to an embodiment.

FIG. 2 is a diagram showing an example of a paper passing route in an in-line scanner.

FIG. 3 is a diagram showing a flow of a paper sheet and data in the image forming system.

FIG. 4 is a flowchart showing an example of an operation of the image forming system according to the present embodiment.

FIG. 5 is a diagram showing an example of a manner in which model regions have been set at the leading and rear ends of a reference image.

FIG. 6 is a diagram showing an example of a manner in which the model regions set for the reference image have been divided into halves.

FIG. 7 is a diagram showing an example of a manner in which an inspection image divided into quarters is input in sequence.

FIG. 8 is a diagram showing an example of the reference image after image correction.

FIG. 9 is a diagram showing an example of the inspection image as read.

FIG. 10 is a diagram showing an example of a case in which a model region where edge information cannot be acquired exists.

### DETAILED DESCRIPTION OF THE EMBODIMENTS

Hereinafter, an embodiment of an image inspection device, an image forming system, an image inspection method, and a recording medium of the present invention will be described on the basis of the drawings. However, the scope of the invention is not limited to the disclosed embodiments.

I. Description of Configuration

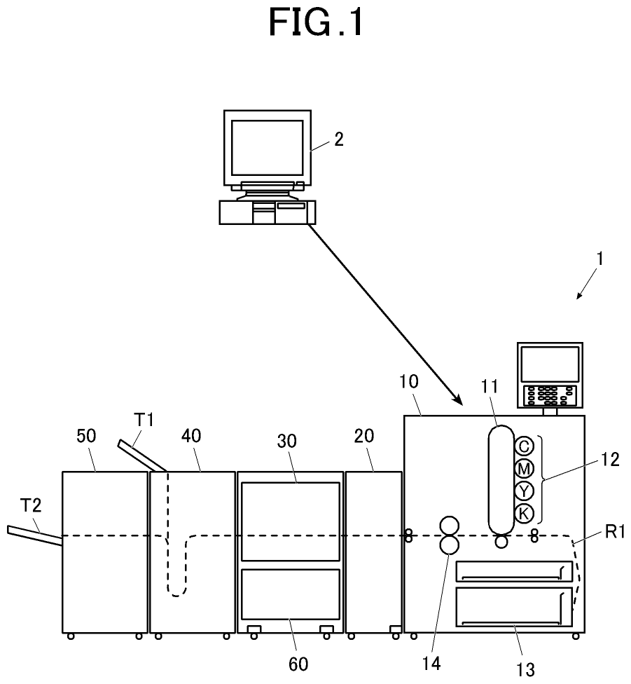

As shown in FIG. 1, an image forming system 1 according to the present embodiment is configured to include an image forming device 10 that receives printing data from an external control device or a server 2, and forms (prints) an image on a paper sheet on the basis of the printing data for output, a relay unit 20 connected to a stage subsequent to the image forming device 10, an in-line scanner 30 connected to a stage subsequent to the relay unit 20, a purge unit 40 connected to a stage subsequent to the in-line scanner 30, a finisher 50 connected to a stage subsequent to the purge unit 40, and an image inspection device 60 that inspects whether or not a printed image is normal for each paper sheet. The reference character R1 in FIG. 1 indicates a conveyance path for paper sheets.

The image forming device 10 is configured to include an endlessly looped intermediate transfer belt 11 and image forming units 12 for respective colors of C (cyan), M (magenta), Y (yellow), and K (black) arranged along this intermediate transfer belt 11, and toner images of respective colors of CMYK are superimposed on the intermediate transfer belt 11 by the image forming units 12 to form a full-color toner image. Then, the image forming device 10 transfers the toner image formed on the intermediate transfer belt 11 onto a paper sheet conveyed from a paper feed tray 13, and further thermally fuses the toner image onto the paper sheet with a fuser 14, and then, outputs the paper sheet toward a device in the subsequent stage (here, the relay unit 20). The image forming device 10 is not limited to one of a tandem-type electrophotographic system as described above, but any system of forming an image on a paper sheet may be employed.

The relay unit 20 relays the paper sheet output from the image forming device 10 further to a device in the subsequent stage (here, the in-line scanner 30). The relay unit 20 has the function of synchronizing the conveyance speed of the paper sheet conveyed from the image forming device 10.

The in-line scanner (reading device) 30 conveys the paper sheet received from the relay unit 20 to the purge unit 40 in the subsequent stage, and scans both the surfaces of the paper sheet during conveyance to optically read images on both the surfaces of the paper sheet, and outputs image data about the read image to the image inspection device 60.

The purge unit 40 conveys a paper sheet determined by the image inspection device 60 that a printed image is normal to the finisher 50 in the subsequent stage, and discharges a paper sheet determined by the image inspection device 60 that a printed image is abnormal to a purge tray T1.

The finisher 50 performs designated post-processing on the paper sheet sent from the purge unit 40, and then discharges the paper sheet to a paper discharge tray T2.

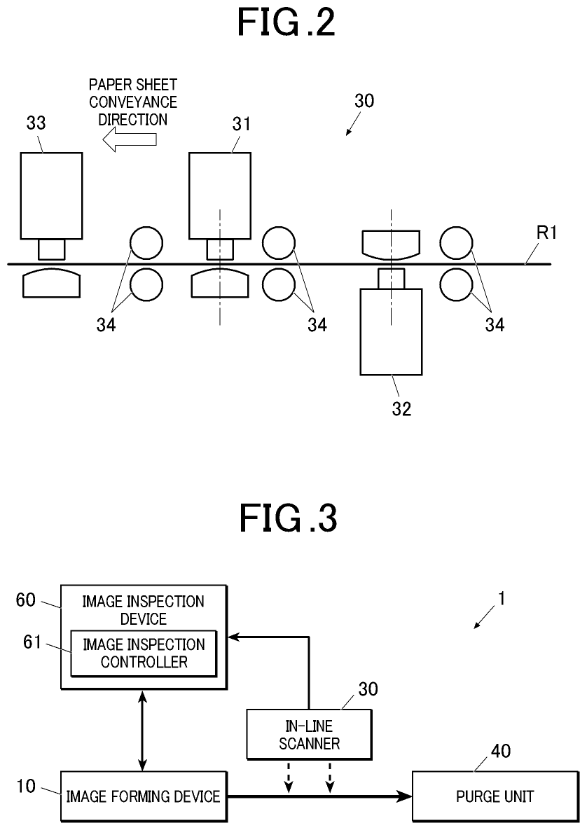

FIG. 2 shows an example of a paper passing route in the in-line scanner 30.

In the in-line scanner 30, an upper side line image sensor 31 that reads the front surface of a paper sheet and a lower side line image sensor 32 that reads the rear surface of the paper sheet are arranged at positions different from each other with a space in the paper sheet conveyance direction in order to read both the surfaces of the paper sheet in one path. In the example shown in FIG. 2, the lower side line image sensor 32 is arranged upstream of the upper side line image sensor 31 in the paper sheet conveyance direction. A colorimeter 33 is provided further downstream of the upper side line image sensor 31.

A paper sheet conveyance mechanism for holding and conveying a paper sheet is provided before and after the respective line image sensors 31 and 32. The paper sheet conveyance mechanism is composed of a pair of conveyor rollers 34 arranged oppositely.

The upper side line image sensor 31 and the lower side line image sensor 32 are fixed at specific places on a conveyance path R1, and a paper sheet being conveyed moves relatively with respect to these reading positions, so that the front and rear sides of the paper sheet are read with the respective line image sensors 31 and 32. In the present embodiment, the direction of conveying a paper sheet will be referred to as the sub scanning direction, and the direction perpendicular to the sub scanning direction on the paper sheet will be referred to as the main scanning direction. The upper side line image sensor 31 and the lower side line image sensor 32 repeat reading a paper sheet conveyed in the sub scanning direction on a line basis in the main scanning direction to read the paper sheet two-dimensionally.

FIG. 3 shows a flow of a paper sheet and data in the image forming system 1.

A paper sheet on which an image has been formed in the image forming device 10 and output is conveyed to the purge unit 40, and on the way, both the surfaces of the paper sheet are read with the in-line scanner 30. The in-line scanner 30 outputs image data obtained by reading toward the image inspection device 60.

The image inspection device 60 is configured to include an image inspection controller 61 (hardware processor).

The image inspection controller 61 functions as a capturer that captures a read image (image data) from a reading device (the in-line scanner 30) that optically reads a paper sheet output from the image forming device 10 that forms an image on the paper sheet and an image inspector that compares a reference image and an inspection image captured by the capturer, obtained by reading the paper sheet on which an image corresponding to the reference image (an image substantially identical to the reference image) has been formed with the in-line scanner 30 to inspect the inspection image. The image inspection controller 61 includes a CPU and a memory, and the CPU reads out and executes a program stored in the memory, so that the functions of the capturer and the image inspector are achieved.

Part or all of the functions of the image inspection device 60 may be configured by a circuit such as an ASIC.

II. Description of Operation

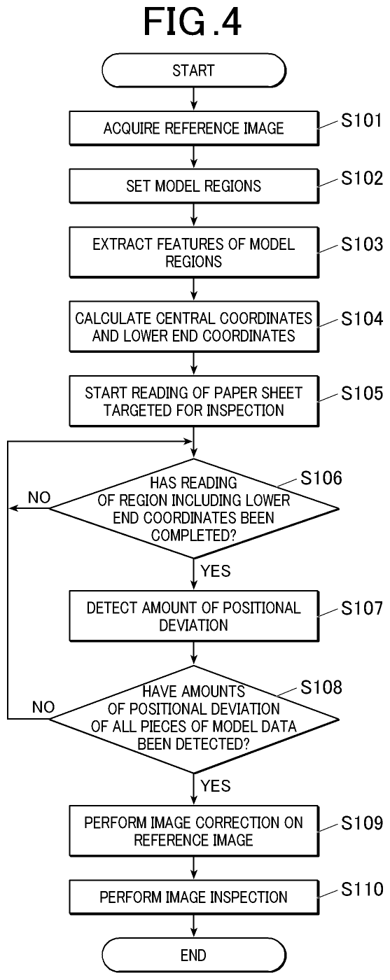

Next, an operation of the image forming system 1 (the image inspection device 60) according to the present embodiment will be described with reference to the flowchart of FIG. 4.

First, the image inspection controller 61 of the image inspection device 60 acquires an image (entire image) obtained by reading a proof with the in-line scanner 30 as a reference image (step S101). The proof has been subjected to adjustment of the image quality and the like through test printing to confirm that there is no problem, and after being printed in the image forming device 10, the entire image is read with the in-line scanner 30.

Next, the image inspection controller 61 sets model regions for the reference image acquired in step S101 (step S102).

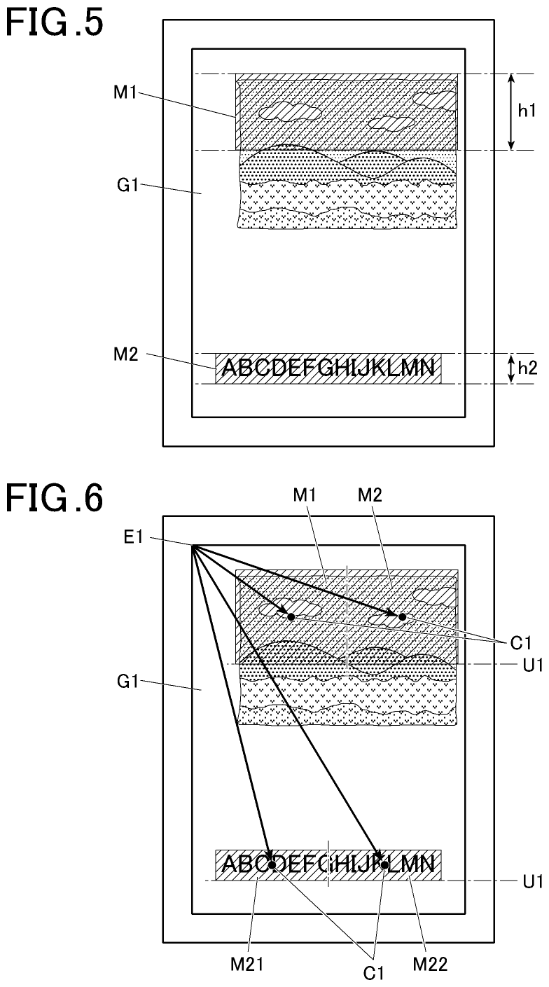

Specifically, the image inspection controller 61 first sets model regions M1 and M2 each having a predetermined width (specifically, a width up to a limit value h1 allowed from performance) at the leading and rear ends of a reference image G1 in a conveyance direction (see FIG. 5). The limit value h1 allowed from performance refers to a limit timing at which a discharge destination of a paper sheet determined as being abnormal as a result of image inspection performed by the image inspection device 60 can be changed to a purge tray T1. This limit value h1 allowed from performance is determined on the basis of a previously defined analysis time. In the example shown in FIG. 5, the model region (first alignment region) M1 having the limit width h1 is set on the leading end side of the reference image G1 in the conveyance direction, and the model region (second alignment region) M2 having a width h2 narrower than the limit width h1 is set on the rear end side of the reference image G1 in the conveyance direction. That is, the image inspection controller 61 functions as a region setter of the present invention. The reason why the width h2 of the model region M2 is narrower than the limit width h1 is because the width (=h2) of an image formed on the paper sheet is narrower than the limit width h1. That is, the image inspection controller 61 sets the first alignment region (the model region M1) for an image closest to the leading end of the paper sheet in the conveyance direction, and sets the second alignment region (the model region M2) for an image closest to the rear end of the paper sheet in the conveyance direction.

Next, the image inspection controller 61 divides each of the model regions M1 and M2 set for the leading and rear ends of the reference image G1 into halves in the direction (main scanning direction) perpendicular to the conveyance direction of the paper sheet (sub scanning direction) (see FIG. 6). In the example shown in FIG. 6, the model region M1 is divided into halves into model regions M11 and M12, and the model region M2 is divided into halves into the model regions M21 and M22. Accordingly, the four model regions M11, M12, M21, and M22 corresponding to the four corners of the reference image G1 are set for the reference image G1.

Next, the image inspection controller 61 creates (alignment) model data in each of the four model regions M11, M12, M21, and M22, and extracts features (edge information, density information, and the like) of each of the four model regions M11, M12, M21, and M22 (step S103). That is, the image inspection controller 61 functions as an extractor of the present invention. In the present embodiment, since the four model regions M11, M12, M21, and M22 are set so as to correspond to the four corners of the reference image G1, model data can be created in regions closest to the four corners in an image (user content) formed on a paper sheet. Accordingly, the accuracy of detecting the amount of positional deviation (the amount of deviation in rotation angle, the amount of deviation in magnification (X/Y), the amount of deviation in shift (X/Y), and the like) can be improved.

Next, the image inspection controller 61 calculates central coordinates and lower end coordinates of each of the four pieces of model data created in step S103 (step S104). Specifically, the image inspection controller 61 calculates central coordinates C1 and lower end coordinates U1 of each of the four pieces of model data created in step S103 using an edge E1 at the upper left of the paper sheet as a reference (see FIG. 6).

Next, the image inspection controller 61 causes the in-line scanner 30 to start reading the paper sheet on which an image corresponding to the reference image has been formed (paper sheet targeted for inspection) (step S105). An image (entire image) obtained by reading the paper sheet targeted for inspection with the in-line scanner 30 is acquired as an inspection image.

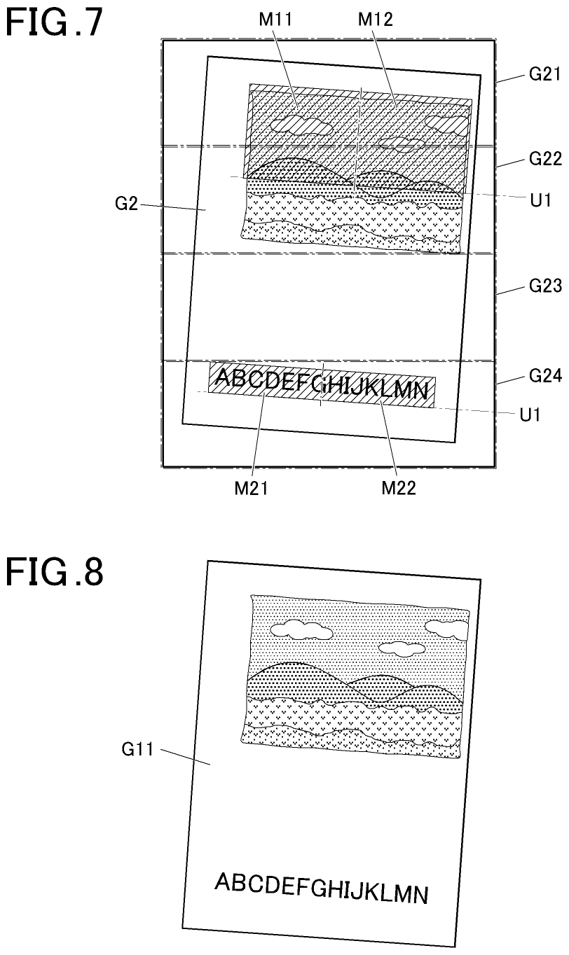

Next, the image inspection controller 61 determines whether or not reading of a region including the lower end coordinates U1 of any of the four pieces of model data has been completed (step S106). In the present embodiment, an inspection image G2 is input in a state divided into a plurality of pieces (four in FIG. 7) in the conveyance direction of the paper sheet (sub scanning direction) in a sequence of being read with the in-line scanner, as shown in FIG. 7. In a case where the lower end coordinates U1 of any of the four pieces of model data are included in divided images G21 to G24 as input, the image inspection controller 61 determines that reading of a region including the lower end coordinates U1 of any of the four pieces of model data has been completed.

In the case where it is determined that reading of the region including the lower end coordinates U1 of any of the four pieces of model data has been completed (YES in step S106), the image inspection controller 61 transitions to the next step S107.

In a case where it is determined that reading of the region including the lower end coordinates U1 of any of the four pieces of model data has not been completed (NO in step S106), the image inspection controller 61 awaits until reading is completed.

Next, the image inspection controller 61 compares the reference image and the inspection image to detect the amount of positional deviation of model data (the model regions M11, M12, M21, and M22) for which reading of the region including the lower end coordinates U1 has been completed (step S107). Specifically, the image inspection controller 61 refers to features (edge information) of model data for which reading has been completed to detect the amount of positional deviation of the center of gravity (central coordinates) of the model data in a state where the edge of model data of the reference image and the edge of model data of the inspection image are matched. That is, the image inspection controller 61 functions as a detector of the present invention.

Since the lower end coordinates U1 are not included in the divided images G21 and G23 in the example shown in FIG. 7, the amount of positional deviation is not detected. Since the lower end coordinates U1 are included in the divided images G22 and G24, the amount of positional deviation is detected.

Next, the image inspection controller 61 determines whether or not the amounts of positional deviation of all pieces of the model data have been detected (step S108).

In a case where it is determined that the amounts of positional deviation of all pieces of the model data have been detected (YES in step S108), the image inspection controller 61 transitions to the next step S109.

In a case where it is determined that the amount of positional deviation of at least one piece of model data has not been detected (NO in step S108), the image inspection controller 61 transitions to step S106 to perform the processing of step S106 again.

Next, the image inspection controller 61 detects an inclination (rotation angle), a magnification, a shift of the inspection image with respect to the reference image on the basis of the detected amounts of positional deviation, and performs image correction (affine transformation or the like) on the reference image (step S109). That is, the image inspection controller 61 functions as a corrector of the present invention. FIG. 8 shows an example of a reference image G11 after the image correction.

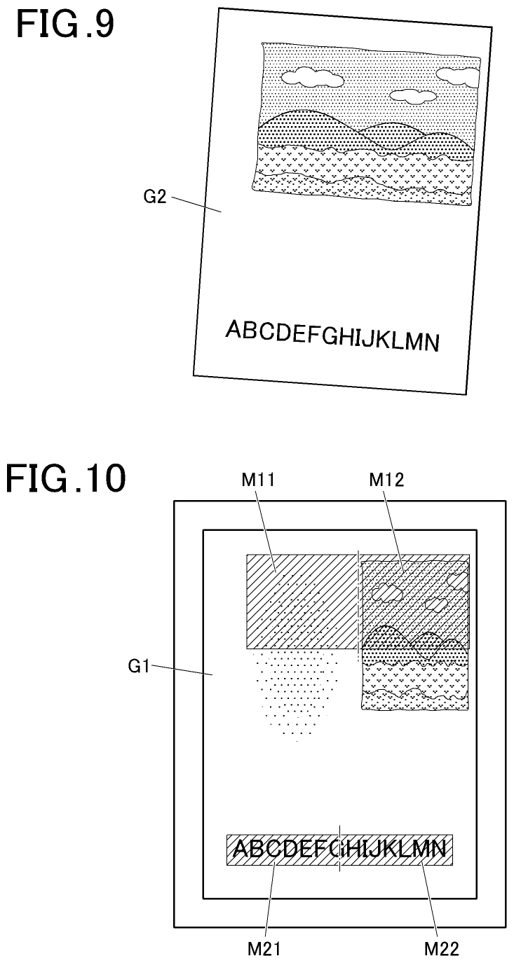

Next, the image inspection controller 61 compares the reference image G11 after the image correction (see FIG. 8) and the inspection image G2 (see FIG. 9) to perform image inspection (step S110). That is, the image inspection controller 61 functions as an image comparator of the present invention.

Thereafter, the image inspection controller 61 changes the discharge destination of a paper sheet determined as being abnormal to the purge tray T1 on the basis of the inspection result in step S110. That is, the image inspection controller 61 functions as a changer of the present invention.

III. Effects

As described above, the image inspection device 60 according to the present embodiment includes a capturer (the image inspection controller 61) that captures a read image from a reading device (the in-line scanner 30) that optically reads a paper sheet output from the image forming device 10 that forms an image on the paper sheet, and an image inspector (the image inspection controller 61) that compares a reference image and an inspection image captured by the capturer, obtained by reading the paper sheet targeted for inspection on which an image corresponding to the reference image has been formed, with the reading device, to inspect the inspection image. The image inspector includes a region setter (the image inspection controller 61) that sets a first alignment region having a predetermined width on the leading end side of each of the reference image and the inspection image in the conveyance direction, and sets a second alignment region having a predetermined width on the rear end side in the conveyance direction, an extractor (the image inspection controller 61) that extracts a feature of each of the first alignment region and the second alignment region set by the region setter, a detector (the image inspection controller 61) that detects the amount of positional deviation of the first alignment region and the second alignment region on the basis of the features extracted by the extractor, a corrector (the image inspection controller 61) that corrects the reference image on the basis the amounts of positional deviation detected by the detector, and an image comparator (the image inspection controller 61) that compares the reference image corrected by the corrector and the inspection image.

Therefore, in accordance with the image inspection device 60 according to the present embodiment, an alignment region can be limited in accordance with an image formed on a paper sheet. Thus, alignment can be performed in an extended region in which an analysis is performed in time before a previously defined time (a time at which paper discharge changing or the like can be performed), so that inspection can be accelerated while ensuring the inspection accuracy.

In accordance with the image inspection device 60 according to the present embodiment, the region setter sets the first alignment region for an image closest to the leading end of the paper sheet in the conveyance direction, and sets the second alignment region for an image closest to the rear end of the paper sheet in the conveyance direction.

Therefore, in accordance with the image inspection device 60 according to the present embodiment, the amount of positional deviation can be detected in a limited manner along with conveyance of a paper sheet. Thus, the time required for detection of the amount of positional deviation can be shortened, so that inspection can be accelerated.

In accordance with the image inspection device 60 according to the present embodiment, the predetermined width is determined on the basis of the previously defined analysis time.

Therefore, in accordance with the image inspection device 60 according to the present embodiment, alignment can be performed in an extended region in which an analysis is performed in time before the previously defined time (the time at which paper discharge changing or the like can be performed), so that inspection can be accelerated while ensuring the inspection accuracy.

In accordance with the image inspection device 60 according to the present embodiment, the extractor extracts a feature in a reference image.

Therefore, in accordance with the image inspection device 60 according to the present embodiment, a feature of an alignment region in the reference image can be extracted before reading an inspection image, so that the timing at which image inspection is completed can be brought forward.

The image inspection device 60 according to the present embodiment also includes a changer (the image inspection controller 61) that changes the discharge destination of a paper sheet targeted for inspection on the basis of an inspection result obtained by the image inspector.

Therefore, in accordance with the image inspection device 60 according to the present embodiment, a paper sheet determined as being abnormal can be discharged separately from a paper sheet determined as being normal, so that an operation of separating an abnormal image after discharging paper sheets can be eliminated.

In accordance with the image inspection device 60 according to the present embodiment, the region setter divides each of the first alignment region and the second alignment region into halves in the direction perpendicular to the conveyance direction to set four alignment regions, and the extractor extracts a feature of each of the four alignment regions set by the region setter, and the detector detects the amounts of positional deviation of the four alignment regions on the basis of the features extracted by the extractor.

Therefore, in accordance with the image inspection device 60 according to the present embodiment, the amounts of positional deviation can be detected in the regions close to the four corners of a paper sheet. Thus, the alignment accuracy can be improved, so that the inspection accuracy can be improved.

In accordance with the image inspection device 60 according to the present embodiment, the detector detects the amounts of positional deviation of the alignment regions in a sequence that reading with the reading device is completed.

Therefore, in accordance with the image inspection device 60 according to the present embodiment, the amount of positional deviation can be detected whenever necessary without awaiting until the entire image is read. Thus, the timing at which image inspection is completed can be brought forward.

Although specific description has been provided above on the basis of an embodiment according to the present invention, the present invention is not limited to the above-described embodiment, but can be modified within a range not departing from its substance.

For example, in the above-described embodiment, the widths of the model regions M1 and M2 in the conveyance direction (specifically, widths up to the limit value h1 allowed from performance) shall be determined on the basis of the previously defined analysis time, but this is not a limitation. For example, the widths (predetermined widths) of the model regions M1 and M2 in the conveyance direction may be determined on the basis of an inspection item. Examples of the inspection item include inspection for dust adhesion, inspection for missing data, inspection for correctness of characters through use of OCR (Optical Character Recognition), and the like. Since loads imposed on an analysis increase in a case where there are a large number of inspection items or a complicated inspection item is performed, the widths of the model regions M1 and M2 in the conveyance direction are made narrower.

As described above, by determining the predetermined widths on the basis of an inspection item, alignment can be performed in time for the previously defined time (the time at which paper discharge changing or the like can be performed) even in a case where loads are imposed on an analysis. Thus, inspection can be accelerated while ensuring the inspection accuracy.

Alternatively, the widths (predetermined width) of the model regions M1 and M2 in the conveyance direction may be determined on the basis of a feature of an image. For example, since loads imposed on an analysis increase in a case where there is a complicated image formed, the widths of the model regions M1 and M2 in the conveyance direction are made narrower.

As described above, by determining the predetermined widths on the basis of a feature of an image, alignment can be performed in time for the previously defined time (the time at which paper discharge changing or the like can be performed) even in a case where loads are imposed on an analysis. Thus, inspection can be accelerated while ensuring the inspection accuracy.

Alternatively, the widths (predetermined widths) of the model regions M1 and M2 in the conveyance direction may be determined on the basis of a conveyance speed of a paper sheet. As the conveyance speed of a paper sheet is faster, the time when arriving at a point where the discharge destination of the paper sheet is changed to the purge tray T1 is shorter, and the time during which an analysis can be performed is shorter. Thus, the widths of the model regions M1 and M2 in the conveyance direction are made narrower.

As described above, by determining the predetermined widths on the basis of the conveyance speed of a paper sheet, alignment can be performed in time for the previously defined time (the time at which paper discharge changing or the like can be performed) even in a case where the time during which an analysis can be performed is shortened. Thus, inspection can be accelerated while ensuring the inspection accuracy.

For example, in the example shown in FIG. 10, a case in which a model region (the model region M11) in which edge information cannot be acquired exists. In general, it is difficult to acquire edge information in a case of a pale gray scale image (gradation image) or the like. In this manner, the model region M11 in which edge information cannot be acquired is set as an alignment region through use of density information.

Since alignment through use of density information is poor in accuracy, the model region M11 through use of density information is not used in a case where there is another model region (the model region M12, M21, M22) in which edge information can be acquired, but the amount of positional deviation for only the model region in which edge information can be acquired is detected. Alternatively, in a case where all of the four model regions M11, M12, M21, and M22 are alignment regions through use of density information, alignment through use of density information is performed.

As described above, the alignment accuracy can be improved by the detector detecting the amount of positional deviation of only an alignment region in which edge information has been extracted by the extractor. Thus, the inspection accuracy can be improved.

In a case where no image has been formed on a paper sheet targeted for inspection, the first alignment region (the model region M1) may be set for the edge of the leading end of the paper sheet targeted for inspection in the conveyance direction, and the second alignment region (the model region M2) may be set for the edge of the rear end of the paper sheet targeted for inspection in the conveyance direction.

As described above, by the region setter setting the first alignment region for the edge of the leading end of the paper sheet targeted for inspection in the conveyance direction and setting the second alignment region for the edge of the rear end of the paper sheet targeted for inspection in the conveyance direction in a case where no image has been formed on the paper sheet targeted for inspection, the amounts of positional deviation can be detected in the vicinity of the edges of the paper sheet. Thus, the alignment accuracy can be improved, so that the inspection accuracy can be improved.

In a case where edge information is extracted in only one alignment region among the four alignment regions by the extractor, the amounts of positional deviation of two alignment regions of an alignment region in which edge information has been extracted and an alignment region positioned diagonally to the alignment region in which edge information has been extracted may be detected.

As described above, by the detector detecting the amounts of positional deviation of two alignment regions of an alignment region in which edge information has been extracted and an alignment region positioned diagonally to the alignment region in which edge information has been extracted in the case where edge information is extracted in only one alignment region among the four alignment regions by the extractor, the amount of positional deviation can be detected using, at minimum, information about the alignment region in which edge information has not been extracted on the basis of the alignment region in which edge information has been extracted. Thus, the alignment accuracy can be ensured, so that the inspection accuracy can be ensured.

In addition, a detailed configuration of each device that constitutes the image forming system and a detailed operation of each device can also be modified as appropriate within a range not departing from the substance of the present invention.

Although embodiments of the present invention have been described and illustrated in detail, the disclosed embodiments are made for purposes of illustration and example only and not limitation The scope of the present invention should be interpreted by terms of the appended claims.

What is claimed is:

1. An image inspection device comprising:
a hardware processor, wherein
the hardware processor
captures a read image from a reading device that optically reads a paper sheet output from an image forming device that forms an image on the paper sheet,
compares a reference image and an inspection image obtained by reading a paper sheet targeted for inspection on which an image corresponding to the reference image has been formed with the reading device, to inspect the inspection image,
sets a first alignment region having a predetermined width on a leading end side of each of the reference image and the inspection image in a conveyance direction, and sets a second alignment region having a predetermined width on a rear end side in the conveyance direction,
extracts a feature of each of the first alignment region and the second alignment region,
detects amounts of positional deviation of the first alignment region and the second alignment region on a basis of the extracted features,
corrects the reference image on a basis of the detected amounts of positional deviation, and
compares the corrected reference image and the inspection image.

2. The image inspection device according to claim 1, wherein the hardware processor sets the first alignment region for an image closest to the leading end of the paper sheet in the conveyance direction, and sets the second alignment region for an image closest to the rear end of the paper sheet in the conveyance direction.

3. The image inspection device according to claim 1, wherein the predetermined width is determined on a basis of a previously defined analysis time.

4. The image inspection device according to claim 1, wherein the predetermined width is determined on a basis of an inspection item.

5. The image inspection device according to claim 1, wherein the predetermined width is determined on a basis of a feature of the image.

6. The image inspection device according to claim 1, wherein the predetermined width is determined on a basis of a conveyance speed of the paper sheet.

7. The image inspection device according to claim 1, wherein the hardware processor extracts the feature in the reference image.

8. The image inspection device according to claim 1, wherein the hardware processor changes a discharge destination of the paper sheet targeted for inspection on a basis of an inspection result.

9. The image inspection device according to claim 1, wherein the hardware processor sets the first alignment region for an edge of the leading end of the paper sheet targeted for inspection in the conveyance direction in a case where no image has been formed on the paper sheet targeted for inspection, and sets the second alignment region for an edge of the rear end of the paper sheet targeted for inspection in the conveyance direction.

10. The image inspection device according to claim 1, wherein the hardware processor detects an amount of positional deviation of only an alignment region in which edge information has been extracted.

11. The image inspection device according to claim 1, wherein the hardware processor
divides each of the first alignment region and the second alignment region into halves in a direction perpendicular to the conveyance direction to set four alignment regions,
extracts a feature of each of the four alignment regions as set, and
detects amounts of positional deviation of the four alignment regions on a basis of the extracted features.

12. The antenna device according to claim 11, wherein, in a case where edge information is extracted in only one alignment region among the four alignment regions, the hardware processor detects amounts of positional deviation of two alignment regions of an alignment region in which edge information has been extracted and an alignment region positioned diagonally to the alignment region in which edge information has been extracted.

13. The antenna device according to claim 1, wherein the hardware processor detects amounts of positional deviation of alignment regions in a sequence that reading with the reading device is completed.

14. An image forming system comprising:
an image forming device that forms an image on a paper sheet;
a reading device that optically reads the paper sheet output from the image forming device; and
the image inspection device as defined in claim 1.

15. An image inspection method for an image inspection device, the image inspection method comprising:
a capturing step of capturing a read image from a reading device that optically reads a paper sheet output from an image forming device that forms an image on the paper sheet; and
an image inspection step of comparing a reference image and an inspection image captured in the capturing step, obtained by reading a paper sheet targeted for inspection on which an image corresponding to the reference image has been formed with the reading device, to inspect the inspection image, wherein
the image inspection step includes
a region setting step of setting a first alignment region having a predetermined width on a leading end side of each of the reference image and the inspection image in a conveyance direction, and setting a second alignment region having a predetermined width on a rear end side in the conveyance direction,
an extraction step of extracting a feature of each of the first alignment region and the second alignment region set in the region setting step,
a detection step of detecting amounts of positional deviation of the first alignment region and the second alignment region on a basis of the features extracted in the extraction step,
a correction step of correcting the reference image on a basis of the amounts of positional deviation detected in the detection step, and
an image comparing step of comparing the reference image corrected in the correction step and the inspection image.

16. A non-transitory recording medium having a computer-readable program stored therein, causing a computer to function as:
a capturer that captures a read image from a reading device that optically reads a paper sheet output from an image forming device that forms an image on the paper sheet; and
an image inspector that compares a reference image and an inspection image captured by the capturer, obtained by reading a paper sheet targeted for inspection on which an image corresponding to the reference image has been formed with the reading device, to inspect the inspection image, wherein
the image inspector includes
a region setter that sets a first alignment region having a predetermined width on a leading end side of each of the reference image and the inspection image in a conveyance direction, and sets a second alignment region having a predetermined width on a rear end side in the conveyance direction,
an extractor that extracts a feature of each of the first alignment region and the second alignment region set by the region setter,
a detector that detects amounts of positional deviation of the first alignment region and the second alignment region on a basis of the features extracted by the extractor,
a corrector that corrects the reference image on a basis of the amounts of positional deviation detected by the detector, and
an image comparator that compares the reference image corrected by the corrector and the inspection image.
